(19) United States
(12) Patent Application Publication
(10) Pub. No.: US 2026/0339910 A1
(43) Pub. Date: Oct. 29, 2026

(54) Recognition-Certified Constant Ledger System and Method for Ingesting, Correcting, Signing, and Distributing Fundamental Physical Constants with Tamper-Evident Provenance Using Recognition-Physics Renormalisation

(71) Applicant: Jonathan Washburn, Austin, TX (US)

(72) Inventor: Jonathan Washburn, Austin, TX (US)

(21) Appl. No.: 19/652,721

(22) Filed: Apr. 20, 2026

Related U.S. Application Data
(60) Provisional application No. 63/794,434, filed on Apr. 25, 2025.

(51) Int. Cl. G06F 16/22; G06F 16/23

(52) U.S. Cl. CPC G06F 16/22; G06F 16/2365

(57) ABSTRACT

Systems and methods are disclosed for ingesting baseline physical-constant data from one or more designated sources, validating and normalizing the data, determining corrected values according to a deterministic correction policy, generating constant records that include baseline values and corrected values, assembling the records into a canonical machine-readable bundle, generating cryptographic attestation artifacts for the bundle, publishing the bundle or an associated identifier, recording a tamper-evident publication record, and enabling independent verification of authenticity, provenance, and transformation integrity. In preferred embodiments, the system operates as a Recognition-Certified Constant Ledger that preserves official baseline values alongside corrected computational-use values in a common verifiable artifact. In certain embodiments, a Recognition-Physics correction policy is applied using a loop correction parameter to generate corrected values. The disclosed systems and methods further support canonical serialization, cryptographic signing, transparency-log recording, supersedence tracking, and recomputation-based verification of published bundles.

### CROSS-REFERENCE TO RELATED APPLICATIONS

This application claims the benefit of U.S. Provisional Patent Application No. 63/794,434, filed on Apr. 25, 2025, the disclosure of which is incorporated herein by reference to the extent permitted and not inconsistent with the present disclosure.

### BACKGROUND OF THE INVENTION

The present invention relates generally to scientific-data provenance, authenticated data distribution, deterministic transformation of physical-constant datasets, and independent verification of transformed scientific reference data. More particularly, the invention relates to systems and methods for ingesting baseline physical-constant data from one or more authoritative or designated sources, validating and normalizing such data, applying one or more deterministic correction policies to one or more constants within the ingested dataset, assembling baseline and corrected values into a canonical machine-readable bundle, cryptographically attesting to the bundle, publishing the bundle to one or more storage or distribution targets, recording tamper-evident transparency information associated with the bundle, and enabling independent verification of authenticity, provenance, version status, and transformed constant values. In certain preferred embodiments, the invention relates to a Recognition-Certified Constant Ledger platform configured to process baseline scientific constants, including physical constants published or distributed by standards bodies, reference authorities, institutional repositories, or other designated baseline sources, and to generate authenticated constant bundles that preserve both baseline values and corrected computational-use values in a common verifiable artifact. In particular implementations, the invention relates to deterministic correction of physical constants using Recognition-Physics or Recognition-Science-derived correction parameters, coefficients, profiles, or policies, including embodiments in which a loop correction parameter, a higher-order series correction, or another deterministic transformation rule is applied across an entire constant table, across selected categories of constants, or across selected individual constants.

Modern scientific, engineering, metrological, computational, and regulatory workflows rely on stable access to physical-constant data. Fundamental constants and related reference quantities are used in simulation software, numerical modeling, calibration pipelines, instrument control systems, firmware environments, scientific publications, compliance filings, and validation workflows across a wide range of technical domains. In many present-day implementations, such constants are distributed through relatively simple publication channels, such as tables in printed or electronic documents, downloadable spreadsheets or comma-separated value files, web pages, repository releases, or application programming interfaces. Although these distribution mechanisms may be adequate for ordinary reference use, they generally do not provide an end-to-end system for deterministic transformation, canonical machine-readable packaging, cryptographic attestation, tamper-evident publication, version chaining, or independent recomputation-based verification of corrected or derived constant datasets.

This creates a technical problem whenever a user, institution, computational platform, or regulated workflow seeks to use not merely a published baseline constant set, but a transformed or corrected constant set whose provenance, derivation path, and publication integrity must be independently verifiable. In many existing environments, corrected or derived constants may be circulated informally through papers, spreadsheets, code repositories, private communications, software commits, release notes, or ad hoc scripts. Such practices are vulnerable to transcription errors, silent revisions, inconsistent versions across teams, incomplete metadata, loss of provenance, unauthorized modification, and inability to reproduce the exact set of constants used in a downstream result. In regulated or audit-sensitive environments, such deficiencies can prevent reliable reconstruction of which constants were used, where they came from, whether they were altered, whether a later release superseded them, and whether the transformed values were computed correctly.

A further deficiency in existing systems is the absence of a robust side-by-side model for handling both official baseline values and corrected computational-use values within a common provenance-preserving framework. In many applications, a standards-body or other designated baseline source may publish a value that remains the official reference value for reporting, traceability, or standards compliance purposes. At the same time, a user or technical framework may wish to use a deterministic transformation, correction, or alternative representation of that baseline value for computational purposes. Existing systems generally do not provide a secure, canonical, and independently verifiable mechanism for publishing both values together in a common bundle while preserving the distinction between the official baseline and the transformed value. This issue is especially sensitive for exact-by-definition constants and for workflows that must clearly distinguish official reference values from computational-use values so as not to imply a redefinition of the underlying standard.

In some embodiments, where a baseline constant is exact by definition or otherwise maintained as an official reference value, the disclosed system preserves that baseline value as the authoritative reference entry while separately storing one or more transformed or corrected computational-use values as distinct machine-identified fields. In this manner, the system supports authenticated computational use of transformed values without implying redefinition of the official baseline itself, and without losing traceability between the official baseline, the applied correction policy, and the resulting computational-use value.

Existing software distribution and repository systems also fail to solve the particular problem addressed by the present invention. Conventional repositories, release systems, file stores, and database exports may provide storage, download, or version labels, but they do not inherently provide a deterministic correction framework tied to baseline constant data, a canonical bundle structure for storing both baseline and corrected values, a cryptographically bound provenance artifact, a transparency-log mechanism for tamper-evident publication, or an independent verifier configured to recompute corrected values from disclosed baseline inputs and correction metadata. Even where cryptographic signatures are used in software distribution, the signature ordinarily attests only to file integrity, not to the correctness of a disclosed physical-constant transformation or to the reproducibility of the transformed constants from the underlying baseline dataset and correction rules.

Related Recognition-Physics and Recognition-Science technologies address adjacent but distinct technical areas and do not, by themselves, solve the full problem addressed herein. For example, an Ecoh-Ledger-type system may provide provenance and attestation for a particular constant, proof object, or foundational reference quantity, but does not provide a platform for ingesting and transforming an entire baseline constant table and distributing the resulting table as a canonical, signed, independently verifiable bundle. Similarly, a Loop-Multiplier Injector-type system may consume corrected constants to modify binaries, executable environments, or runtime computational behavior, but such a system depends on some upstream source of corrected constants and does not itself provide the full ingest, transform, canonicalize, sign, publish, transparency-log, version, and verify workflow disclosed herein. Standalone renormalisation engines or theoretical derivation engines may produce transformed values or correction parameters, but they do not by themselves provide the authenticated dataset-distribution and independent-verification infrastructure needed to make such values operationally reliable across software, enterprise, academic, and regulatory environments.

Accordingly, there exists a need for systems and methods that can ingest one or more baseline physical-constant datasets from one or more authoritative or designated sources, validate and normalize such datasets, apply one or more deterministic correction policies to one or more constants within those datasets, preserve official baseline values alongside corrected computational-use values, package the resulting data and metadata into a canonical machine-readable bundle, generate one or more cryptographic attestation artifacts for the bundle, publish the bundle or a corresponding identifier to one or more storage or distribution targets, record tamper-evident transparency information associated with publication of the bundle, maintain versioning and supersedence relationships across multiple bundle releases, and enable an independent verifier to confirm authenticity, provenance, bundle integrity, and transformation correctness without requiring blind trust in the publisher. The present invention addresses these and other technical needs.

In some embodiments, the disclosed technology improves computer operation and scientific-computation integrity not by merely storing or presenting reference data, but by imposing a deterministic machine workflow that transforms baseline constant data into a canonical, cryptographically attestable, independently verifiable artifact suitable for automated downstream use. In some embodiments, the technical effect includes reducing silent value drift across distributed software environments, reducing ambiguity in constant selection across builds and deployments, and enabling machine-verifiable acceptance or rejection of constant bundles before such bundles are used by simulators, firmware generators, validation systems, or other computational workflows.

### SUMMARY OF THE INVENTION

The present invention provides systems and methods for ingesting baseline physical-constant data from one or more authoritative or designated sources, validating and normalizing such data, applying one or more deterministic correction policies to one or more constants within the ingested dataset, generating corrected constant records, assembling baseline values, corrected values, and associated provenance metadata into a canonical machine-readable bundle, cryptographically attesting to the bundle, publishing the bundle or an identifier associated therewith to one or more storage, archive, repository, or distribution targets, recording tamper-evident transparency information associated with publication of the bundle, and enabling independent verification of authenticity, provenance, bundle integrity, version status, and transformation correctness. In preferred embodiments, the invention is implemented as a Recognition-Certified Constant Ledger platform that functions as an authenticated source of baseline and corrected physical-constant data for downstream scientific, industrial, regulatory, academic, enterprise, and computational uses.

In one aspect, the invention provides a computer-implemented method in which baseline physical-constant data is received from one or more sources, parsed into internal records, validated for numerical, structural, and semantic consistency, and normalized into a common internal format. One or more correction policies are then selected or applied to the baseline data. In various embodiments, the correction policy may comprise a global correction applied across a plurality of constants, a per-category correction policy, a per-constant correction policy, a profile-based correction policy, a theory-tagged correction policy, a first-order correction policy, a higher-order series correction policy, an annotation-only policy, or a comparison-mode policy configured to generate multiple transformed values for a common baseline input. The resulting corrected values are stored together with baseline values and provenance metadata, thereby preserving both the official baseline and one or more corrected computational-use values in a common artifact.

In another aspect, the invention provides a system comprising an ingestion engine, a correction engine, a canonical bundle maker, a sign-and-publish module, and a verifier. The ingestion engine is configured to receive baseline constant data in one or more formats, including but not limited to tabular files, structured data files, application programming interface responses, or mirrored dataset releases, and to generate validated baseline records with associated source metadata. The correction engine is configured to determine one or more correction parameters, coefficients, orders, profiles, or transformation rules and to generate corrected values from the baseline records. The canonical bundle maker is configured to serialize the resulting data into a deterministic machine-readable representation that includes baseline values, corrected values, correction metadata, provenance metadata, release metadata, and verification-relevant metadata. The sign-and-publish module is configured to generate one or more cryptographic attestation artifacts, including at least a digest and a digital signature in certain embodiments, and to publish the bundle, a content-addressed identifier, or both, to one or more storage or distribution locations while also recording tamper-evident transparency information. The verifier is configured to retrieve the bundle or identifier, validate authenticity and provenance, independently recompute one or more transformed values from disclosed inputs and correction data, and output a verification result.

In certain preferred embodiments, the correction engine applies a Recognition-Physics or Recognition-Science-derived correction policy. In one disclosed embodiment, a loop correction parameter is determined from a deterministic expression involving X_opt and R_RP, where X_opt=phi/pi and R_RP= 7/12, and wherein delta_loop=X_opt\hat{ }(1+R_RP). In one first-order embodiment, a corrected value is determined according to C_star=C*(1−delta_loop). In one higher-order embodiment, a corrected value is determined according to C_star=C*sum_{n=0 to N}(a_n*delta_loop\hat{ }n). The invention is not limited to a single correction rule, however, and in broader embodiments encompasses any deterministic policy by which one or more baseline constants are transformed, annotated, compared, or otherwise processed for authenticated publication and verification. In preferred implementations, the correction metadata stored with a corrected record may include one or more of a correction-policy identifier, correction order, coefficient-set identifier, correction parameter value, provenance reference, derivation-input identifier, theoretical profile identifier, or engine version identifier.

In another aspect, the invention provides a canonical bundle structure configured to preserve both substantive scientific data and verification-relevant metadata in a single machine-readable artifact. In preferred embodiments, the bundle includes a schema version, source release identifier, correction-method identifier, timestamp, publisher identifier, public-key or fingerprint information, one or more bundle-level correction fields, and an array or collection of constant records. Each constant record may include, by way of non-limiting example, a name, symbol, baseline value, baseline uncertainty, corrected value, corrected uncertainty, exactness indicator, unit, source release metadata, correction order, correction parameter value, provenance reference, engine version, and record hash or other integrity field. In some embodiments, the bundle further includes a supersedes field, a replaced_by field, compatibility metadata, subset metadata, comparison metadata, proof references, or one or more references to transparency-log entries or anchoring artifacts. The canonical bundle may be represented in canonical JSON, canonical CBOR, canonical XML, a typed-binary representation, or another deterministic encoding suitable for hashing, signing, storage, and recomputation-based verification.

In a further aspect, the invention provides cryptographic attestation and publication mechanisms by which a canonical bundle may be hashed, signed, replicated, and made tamper-evident across one or more publication environments. In one embodiment, a digest is generated according to hash=HASH(canonical_bundle_bytes), and in a more specific embodiment hash=SHA-256(canonical_bundle_bytes). In one embodiment, a digital signature is generated according to sig=SIGN(private_key, hash), and in a more specific embodiment sig=Ed25519.sign(k_priv, hash). The resulting signed bundle, detached signature, embedded signature block, digest, content-addressed identifier, or related publication artifact may be published to one or more content-addressed networks, permanent archives, release repositories, enterprise stores, write-once stores, or other distribution targets. In some embodiments, publication is replicated across multiple targets, and the system stores acknowledgment, manifest, health, or availability data associated with such publication. In some embodiments, signing is performed by or with assistance from an HSM, secure enclave, threshold-signature system, multi-signature system, or other secure key-management environment.

In another aspect, the invention provides a transparency ledger and append-only audit mechanism. In preferred embodiments, each publication is associated with a tamper-evident entry containing one or more of a bundle identifier, content-addressed identifier, digest, signature reference, timestamp, epoch identifier, and index within an epoch. In certain embodiments, entries are grouped into epochs, leaves are committed into a Merkle structure, a root is generated for an epoch, and one or more inclusion proofs are produced to allow a verifier to confirm that a bundle publication was committed to the log. In some embodiments, the root or a derivative thereof is further anchored to an external anchoring environment, which may comprise a blockchain system, a notarization system, a consortium log, a private enterprise log, or another external or semi-external anchor record. In some implementations, multi-epoch historical verification is supported such that an earlier bundle remains verifiable even after later bundles are published and even after one or more supersedence relationships are established.

In another aspect, the invention provides an independent verifier that does not merely trust the stored corrected values, but instead recomputes one or more transformed values from disclosed baseline inputs and correction metadata. In one embodiment, the verifier retrieves a bundle, recomputes a bundle digest, verifies one or more signatures, recomputes one or more correction parameters, recomputes one or more corrected constant values, compares the recomputed values against the published values, verifies one or more transparency proofs, verifies one or more anchor records, and produces an output indicating validity or invalidity. In preferred embodiments, the verifier may additionally generate warning states, including but not limited to superseded-bundle warnings, replacement warnings, withdrawn-bundle warnings, unsupported-profile warnings, partial-verification warnings, or stale-root warnings. In some embodiments, the verifier supports full verification, signature-only verification, provenance-only verification, recalculation-only verification, proof-only verification, selected-subset extraction verification, or offline verification against cached roots, cached trust anchors, or cached key-status information.

In still another aspect, the invention provides explicit lifecycle and version-management functionality for authenticated constant bundles. In preferred embodiments, a newly published bundle may supersede a prior bundle while preserving the prior bundle in a historically discoverable and independently verifiable state. A bundle may be marked superseded, replaced, deprecated, corrected, or withdrawn while remaining part of the historical publication chain. A replacement notice may identify a later bundle that corrects, updates, or supersedes an earlier bundle. New source releases, new correction-policy versions, new signing keys, new proof structures, or new bundle schemas may each trigger publication of a new bundle while maintaining continuity through version metadata, supersedes metadata, replacement metadata, or transparency-log relationships. In this manner, the invention provides not merely file publication, but an authenticated and historically traceable lifecycle for corrected physical-constant datasets.

In further aspects, the invention supports a broad range of deployment and integration environments. In certain embodiments, the system is implemented as a command-line tool, browser-based verifier, Python package, notebook plug-in, embedded verifier, enterprise verifier service, API endpoint, streaming service, subscription service, build-system gate, compliance-report generator, or regulatory audit package generator. In some embodiments, a verified bundle or selected extracted constants are delivered to scientific software, simulation environments, firmware build systems, compiled-binary workflows, containerized systems, high-performance computing environments, academic notebooks, enterprise analysis pipelines, or runtime constant-injection environments. In certain embodiments, the platform interoperates with downstream systems such as Loop-Multiplier Injector environments, allowing the ledger to serve as an authoritative source of verified constants while downstream systems consume or inject such constants into other computational contexts.

In additional embodiments, the invention supports multi-theory and comparison workflows in which multiple correction frameworks, methodologies, or theory-tagged transformation policies are represented within a common authenticated infrastructure. In such embodiments, a user may compare baseline values, Recognition-Physics-corrected values, alternative-theory-corrected values, or profile-specific corrected values using a shared bundle or a shared comparison structure. In further embodiments, the invention supports real-time or near-real-time update publication, streaming distribution, threshold-signature publication, HSM-backed publication ceremonies, academic federation signing, enterprise mirror deployments, compliance-package generation, audit-only manifests, selective extraction bundles, differential update bundles, and other alternatives disclosed herein. Thus, the invention is not limited to a single storage medium, signature scheme, publication target, verifier implementation, or theory framework, but instead provides a general infrastructure for authenticated distribution and independent verification of corrected physical-constant datasets.

The invention accordingly provides significant technical advantages over conventional constant-distribution and repository systems. Among other advantages, the invention enables authenticated publication of entire constant tables rather than isolated values, preserves baseline and corrected values in a common artifact, supports deterministic machine-readable bundle formation, provides cryptographic and transparency-layer tamper evidence, enables independent recomputation-based verification, supports historical verifiability across multiple releases, and integrates with scientific, industrial, enterprise, academic, and regulatory workflows without requiring blind trust in a publisher. These and other objects, features, and advantages of the invention will become apparent from the following description, drawings, and claims.

### BRIEF DESCRIPTION OF THE DRAWINGS

The foregoing and other objects, features, and advantages of the invention will be more readily understood from the following detailed description, taken in conjunction with the accompanying drawings, in which like reference numerals refer to like elements throughout the various figures, and in which reference numerals are assigned in figure-specific series using even-number spacing, such that FIG. 1 uses the 100 series, FIG. 2 uses the 200 series, FIG. 3 uses the 300 series, FIG. 4 uses the 400 series, FIG. 5 uses the 500 series, FIG. 6 uses the 600 series, FIG. 7 uses the 700 series, and FIG. 8 uses the 800 series. In the drawings, certain elements, modules, data structures, interfaces, and relationships may be shown schematically, diagrammatically, or functionally for clarity, and the drawings are not necessarily to scale.

FIG. 1 is a schematic diagram of an example Recognition-Certified Constant Ledger ecosystem showing an RCCL system 100 in communication with one or more baseline sources 102, an ingestion engine 104, a correction engine 106, a canonical bundle maker 108, a sign-and-publish module 110, one or more distributed storage targets 112, a transparency ledger 114, a verifier 116, an optional provenance reference source 118, an optional downstream injector environment 120, one or more downstream scientific applications 122, one or more auditor or regulator interfaces 124, and one or more networks 126.

FIG. 2 is a schematic diagram of an example source-acquisition, parsing, normalization, and validation pipeline showing a source dataset 200 received through an acquisition interface 202, parsed by a parser 204, mapped by a schema mapper 206, validated by a unit validator 208 and an uncertainty validator 210, tagged by a version tagger 212, checked by a completeness checker 214, normalized by a normalization module 216, routed through an exception handler 218 where appropriate, and stored in a baseline record store 220 and a metadata store 222 with an associated release identifier 224.

FIG. 3 is a schematic diagram of an example correction-policy engine and RP-specific correction embodiment showing a correction engine 300 including a correction-policy selector 302, a correction-parameter generator 304, an X_opt calculator 306, a correction-order selector 308, a first-order correction branch 310, a higher-order correction branch 312, a coefficient store 314, a corrected-value calculator 316, a corrected-uncertainty calculator 318, a provenance linker 320, and a corrected-record output 322.

FIG. 4 is a schematic diagram of an example constant-record data structure showing a constant record 400 including a name field 402, a symbol field 404, a baseline value field 406, a baseline uncertainty field 408, a corrected value field 410, a corrected uncertainty field 412, a unit field 414, a source release field 416, a correction order field 418, a correction-parameter field 420, a provenance reference field 422, an engine version field 424, an exactness flag 426, and a record hash 428.

FIG. 5 is a schematic diagram of an example canonical bundle schema and serialization process showing a canonical bundle 500 including a header 502, a schema version field 504, a source release field 506, a correction method field 508, a bundle-level correction field 510, a timestamp field 512, a public-key fingerprint field 514, a constants array 516 containing one or more constant entries 518, a supersedes field 520, a bundle hash field 522, a signature block 524, and a canonicalizer 526 configured to generate a deterministic machine-readable representation of the bundle.

FIG. 6 is a schematic diagram of an example hashing, signing, publication, and transparency-log workflow showing a sign-and-publish subsystem 600 including a hash generator 602, a key store 604, a signature generator 606, a content-address generator 608, a primary publisher 610, a backup publisher 612, an archive or release publisher 614, a publication manifest 616, a transparency-log entry builder 618, and a transparency ledger 620.

### DETAILED DESCRIPTION OF THE INVENTION

The present invention will now be described more fully with reference to the accompanying drawings, in which preferred embodiments of the invention are shown. The invention may, however, be embodied in many different forms and should not be construed as limited to the embodiments set forth herein. Rather, these embodiments are provided so that this disclosure will be thorough and complete, and will fully convey the scope of the invention to those of ordinary skill in the art. Like reference numerals refer to like elements throughout the drawings.

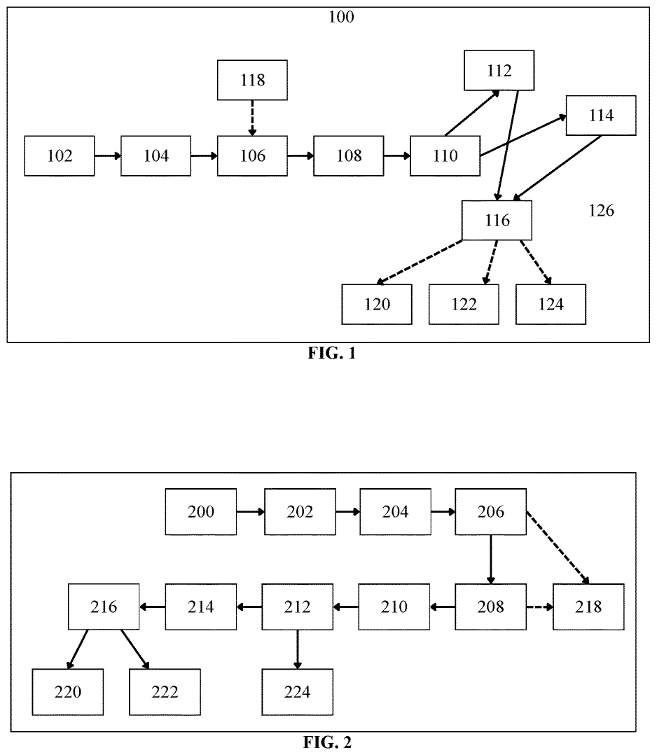

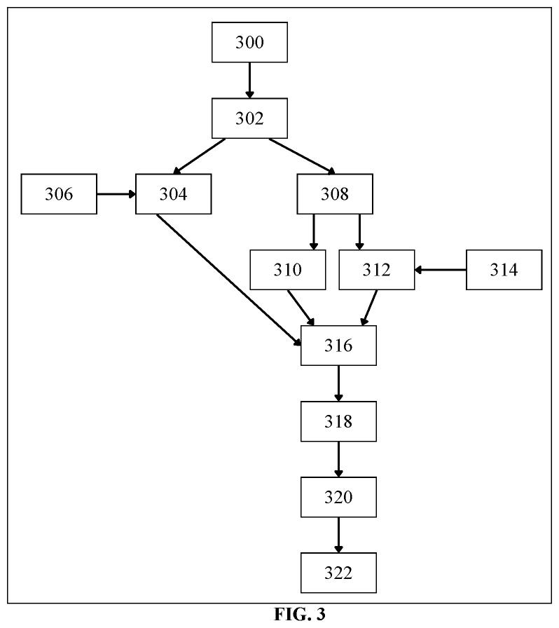

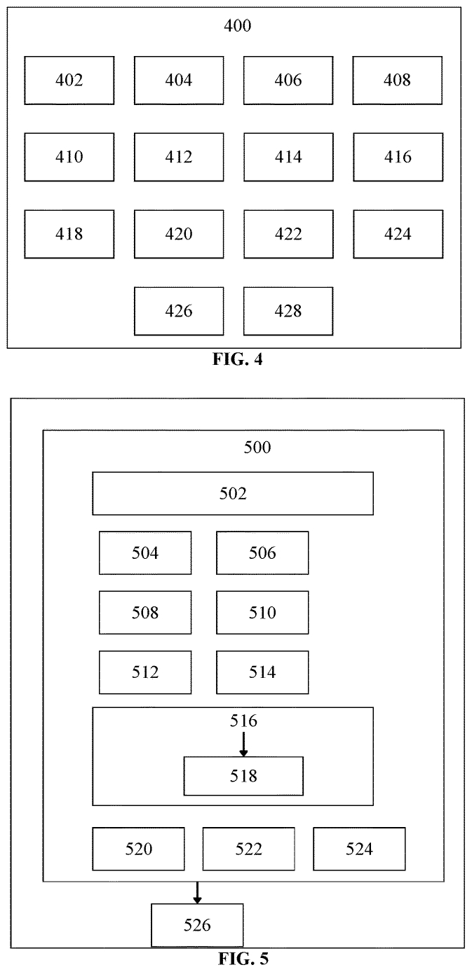

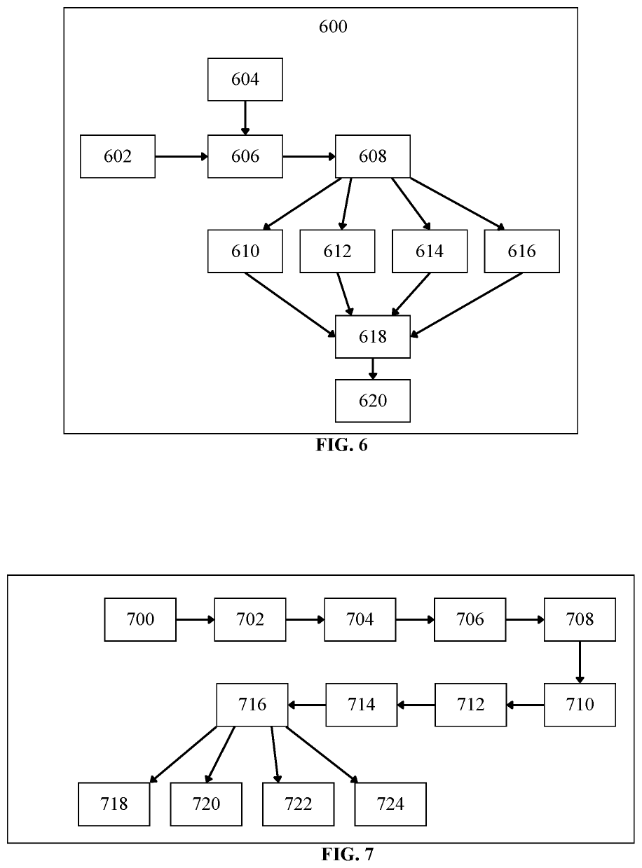

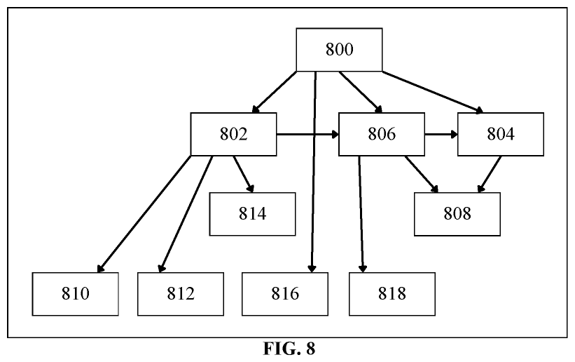

Reference numerals are assigned in figure-specific series using even-number spacing, such that FIG. 1 uses the 100 series, FIG. 2 uses the 200 series, FIG. 3 uses the 300 series, FIG. 4 uses the 400 series, FIG. 5 uses the 500 series, FIG. 6 uses the 600 series, FIG. 7 uses the 700 series, and FIG. 8 uses the 800 series. Unless expressly stated otherwise, directional, relational, and organizational descriptions are provided for explanatory convenience and do not require a particular physical arrangement, implementation order, network topology, storage topology, or deployment architecture.

As shown in FIG. 1, an example Recognition-Certified Constant Ledger system 100 is configured to receive baseline physical-constant data from one or more baseline sources 102, process such data through an ingestion engine 104, transform one or more constants using a correction engine 106, assemble the resulting data into a canonical bundle by a canonical bundle maker 108, cryptographically attest to and distribute the bundle by a sign-and-publish module 110, store or replicate the bundle at one or more distributed storage targets 112, record tamper-evident publication information in a transparency ledger 114, and enable independent validation by a verifier 116. In optional embodiments, the system 100 may further communicate with a provenance reference source 118, a downstream injector environment 120, one or more downstream scientific applications 122, one or more auditor or regulator interfaces 124, and one or more networks 126. The system 100 may be implemented as a standalone platform, an enterprise-hosted service, a local software toolchain, a hybrid on-premises and cloud deployment, or any suitable combination thereof.

For purposes of this disclosure, a “baseline constant” refers to a physical, metrological, scientific, or other reference value obtained from an authoritative, designated, or otherwise selected source prior to application of a correction policy by the system 100. A “baseline dataset” refers to a collection of such baseline constants, whether in tabular, structured, serialized, streamed, or otherwise transmitted form. A “standards-body source” refers to any organization, body, authority, repository, publisher, or designated source that publishes or distributes baseline values intended for reference, standardization, reproducibility, traceability, or technical use. A “constant record” refers to an internal or published representation of a constant including at least a baseline value and associated metadata, and in many embodiments including one or more corrected values and one or more verification-relevant fields. A “corrected constant” refers to a baseline constant that has been transformed, adjusted, annotated, or otherwise processed according to one or more deterministic correction policies. A “correction policy” refers broadly to any deterministic rule, function, transformation, algorithm, coefficient set, or profile according to which a baseline constant may be processed. A “correction profile” refers to a selected configuration, methodology, or policy identity associated with a particular set of correction behaviors. A “correction order” refers to an order, level, degree, or series depth associated with a given correction method, including but not limited to first-order and higher-order embodiments. A “correction parameter” refers to any parameter, value, coefficient, set of coefficients, or derived quantity used in a correction policy.

Turning to FIG. 2, an example source dataset 200 is received through an acquisition interface 202 and processed by a parser 204, which may parse one or more files, streams, responses, or payloads into internal structures. A schema mapper 206 may then map source fields into a common internal representation. In preferred embodiments, a unit validator 208 validates, normalizes, or otherwise processes unit information, and an uncertainty validator 210 validates, normalizes, or otherwise processes uncertainty information where applicable. A version tagger 212 may associate a release identity, source version, publication year, release label, or other version metadata with the ingested data. A completeness checker 214 may evaluate whether an expected quantity, category, or threshold of data has been received. A normalization module 216 may normalize field formats, field names, numeric formats, internal data structures, enumerations, or metadata structures. An exception handler 218 may handle missing fields, malformed records, non-finite values, schema mismatches, unsupported units, duplicate entries, incomplete payloads, or other conditions. Validated records may be stored in a baseline record store 220, and associated source, acquisition, and processing metadata may be stored in a metadata store 222 together with a release identifier 224. Although FIG. 2 shows a staged pipeline, the functions of the acquisition interface 202, parser 204, schema mapper 206, unit validator 208, uncertainty validator 210, version tagger 212, completeness checker 214, normalization module 216, exception handler 218, baseline record store 220, metadata store 222, and release identifier 224 may be combined, reordered, distributed, parallelized, or subdivided across implementations.

In some embodiments, the source dataset 200 may be received in CSV, JSON, XML, application programming interface, mirrored repository, local file, archive, or enterprise-repository form. In some embodiments, the source dataset 200 may correspond to a standards-body release of physical constants. In other embodiments, the source dataset 200 may correspond to an institutional, enterprise, academic, regulatory, or simulation-specific constant set. Validation performed by the unit validator 208 and uncertainty validator 210 may include checking for finite numeric values, positivity where physically required, consistency of unit syntax, consistency of uncertainty units with baseline values, presence or absence of uncertainty depending on exactness status, and compatibility with designated schemas. The completeness checker 214 may enforce minimum counts, expected category coverage, mandatory fields, or source-specific completeness thresholds. The exception handler 218 may reject records, quarantine records, request manual review, generate warnings, or apply policy-based handling for non-conforming inputs. In some embodiments, the system 100 may retain historical release information such that re-ingestion of a new source release produces a new bundle while preserving earlier release-linked bundles for later verification and comparison.

FIG. 3 illustrates an example correction engine 300. The correction engine 300 may include a correction-policy selector 302 configured to select or apply one or more correction policies, a correction-parameter generator 304 configured to derive or retrieve one or more correction parameters, an X_opt calculator 306 configured in certain embodiments to derive X_opt, a correction-order selector 308 configured to select a first-order or higher-order mode, a first-order correction branch 310, a higher-order correction branch 312, a coefficient store 314, a corrected-value calculator 316, a corrected-uncertainty calculator 318, a provenance linker 320, and a corrected-record output 322. The correction engine 300 is not limited to a single mathematical policy and may be configured to apply a global correction policy, a per-category policy, a per-constant policy, a profile-based policy, a theory-tagged policy, an annotation-only policy, or a comparison-mode policy in which multiple corrected outputs are derived from a common baseline input. In some embodiments, the correction-policy selector 302 may select a policy based on source release, target application, user selection, verification requirements, deployment profile, theory tag, security policy, or regulator profile.

In a preferred RP-specific embodiment, the correction-parameter generator 304 derives a correction parameter from Recognition-Physics or Recognition-Science inputs. In one embodiment, X_opt is determined by the X_opt calculator 306 according to X_opt=phi/pi. In one embodiment, R_RP= 7/12. In one embodiment, delta_loop is then determined according to delta_loop=X_opt\hat{ }(1+R_RP). In a first-order embodiment, the first-order correction branch 310 and corrected-value calculator 316 generate a corrected value according to C_star=C*(1−delta_loop). In a higher-order embodiment, the higher-order correction branch 312 and corrected-value calculator 316 generate a corrected value according to C_star=C*sum_{n=0 to N}(a_n*delta_loop\hat{ }n), where the coefficient store 314 stores, retrieves, or otherwise provides one or more coefficients a_n. In broader embodiments, the correction engine 300 may apply other deterministic transformations while retaining the same authenticated ingest-to-publish-to-verify architecture. The provenance linker 320 may associate a corrected value with one or more provenance references, including a provenance reference source 118, an engine version, a coefficient-set identifier, a derivation-input identifier, or a theory-profile identifier, and the corrected-record output 322 may then provide the resulting corrected record for bundle assembly.

FIG. 4 illustrates an example constant record 400. In the depicted embodiment, the constant record 400 includes a name field 402, a symbol field 404, a baseline value field 406, a baseline uncertainty field 408, a corrected value field 410, a corrected uncertainty field 412, a unit field 414, a source release field 416, a correction order field 418, a correction-parameter field 420, a provenance reference field 422, an engine version field 424, an exactness flag 426, and a record hash 428. In some embodiments, the name field 402 and symbol field 404 identify the constant semantically, the baseline value field 406 stores the official or source-designated baseline value, the baseline uncertainty field 408 stores an uncertainty where applicable, the corrected value field 410 stores a transformed computational-use value, and the corrected uncertainty field 412 stores a derived or associated uncertainty. The unit field 414 stores a unit or dimensional designation, the source release field 416 stores source-version information, the correction order field 418 stores an order or mode of correction, the correction-parameter field 420 stores delta_loop or another policy-specific parameter, the provenance reference field 422 stores one or more provenance references or identifiers, the engine version field 424 stores a version of a transformation engine or policy implementation, the exactness flag 426 indicates whether the baseline is exact by definition or otherwise specially designated, and the record hash 428 provides a record-level integrity artifact in certain embodiments. Additional fields may be included, omitted, combined, or subdivided in other embodiments.

In preferred embodiments, the constant record 400 preserves both the official baseline and the corrected computational-use value in a single provenance-bound structure. This dual-preservation design is particularly useful where a standards-body baseline remains authoritative for standards or reporting purposes, while a transformed value is desired for computational, theoretical, or engineering purposes. The exactness flag 426 may be used to indicate that a baseline quantity is exact by definition. In some embodiments, the corrected value field 410 may still be populated for such a constant to support computational-use workflows, while in other embodiments the corrected value field 410 may be omitted or suppressed for selected exact-by-definition constants. Likewise, the corrected uncertainty field 412 may be derived, preserved, left blank, or replaced with another indicator depending on the correction policy and the treatment of exactness. In this way, the constant record 400 supports both strict baseline preservation and deterministic computational-use transformation without implying redefinition of the official baseline.

FIG. 5 illustrates an example canonical bundle 500. The canonical bundle 500 may include a header 502, a schema version field 504, a source release field 506, a correction method field 508, a bundle-level correction field 510, a timestamp field 512, a public-key fingerprint field 514, a constants array 516, one or more constant entries 518, a supersedes field 520, a bundle hash field 522, a signature block 524, and a canonicalizer 526. In preferred embodiments, the canonicalizer 526 deterministically serializes the bundle 500 according to one or more canonicalization rules so that the same substantive content yields the same canonical representation. Such rules may include deterministic key ordering, deterministic array ordering, deterministic numeric formatting, defined handling of null or optional fields, defined encoding rules, and exclusion of non-canonical variations such as unordered fields, comments, or unsupported syntactic extensions.

As used herein, “deterministic numeric formatting” refers to formatting rules that yield the same canonical text or byte representation for a given numeric value under the applicable schema, independent of runtime environment. Non-limiting examples include: formatting floating-point values using a fixed significant-digit rule; formatting floating-point values using a shortest-roundtrip representation that uniquely round-trips to the same IEEE-754 binary value; normalizing exponent notation and sign characters; and disallowing locale-dependent formatting. In embodiments using uncertainty fields, the uncertainty value is formatted under the same determinism rules as the baseline and corrected values.

The constants array 516 may contain one or more constant entries 518, each of which may correspond to a constant record 400 or a transformed form thereof. The bundle-level correction field 510 may store a global correction parameter, a profile identifier, a correction policy identifier, or other bundle-scope correction metadata. The supersedes field 520 may identify an earlier bundle replaced or updated by the current bundle 500. The bundle hash field 522 and signature block 524 may be added after canonicalization or incorporated in an embodiment-specific attestation structure.

In certain embodiments, the canonicalization rules include an explicit and testable determinism requirement, such that two independent implementations that receive identical bundle content (including identical numeric values, units, schema version, and field population) produce byte-identical canonical bundle bytes prior to hashing and signing. In some implementations, determinism is validated by comparing canonical bundle bytes across at least two independent canonicalizer implementations or across at least two independent runtime environments.

The canonical bundle 500 may be represented in canonical JSON, canonical CBOR, canonical XML, typed-binary form, line-oriented manifest form, or another deterministic representation. In one embodiment, a canonical representation is generated and then a digest is computed according to hash=HASH(canonical_bundle_bytes). In one embodiment, the digest is computed according to hash=SHA-256(canonical_bundle_bytes). In one embodiment, a signature is generated according to sig=SIGN(private_key, hash). In one embodiment, the signature is generated according to sig=Ed25519.sign(k_priv, hash). These specific equations and algorithms are provided as examples of disclosed embodiments and do not limit broader embodiments in which other deterministic hash, signature, or attestation schemes are used. The use of the canonicalizer 526 and the canonical bundle 500 enables independently reproducible hashing, signing, and verification across different implementations and environments.

FIG. 6 illustrates an example sign-and-publish subsystem 600 configured to generate one or more attestation artifacts for a canonical bundle and to distribute the resulting publication artifacts in a tamper-evident manner. In the illustrated embodiment, the sign-and-publish subsystem 600 includes a hash generator 602, a key store 604, a signature generator 606, a content-address generator 608, a primary publisher 610, a backup publisher 612, an archive or release publisher 614, a publication manifest 616, a transparency-log entry builder 618, and a transparency ledger 620. In operation, the hash generator 602 receives the canonical representation of the bundle 500 and generates a digest therefrom. In one embodiment, the digest is generated according to hash=HASH(canonical_bundle_bytes). In one embodiment, the digest is generated according to hash=SHA-256(canonical_bundle_bytes). The key store 604 stores, accesses, or interfaces with one or more cryptographic keys or key-management services, and the signature generator 606 generates a signature or equivalent attestation artifact. In one embodiment, the signature is generated according to sig=SIGN(private_key, hash). In one embodiment, the signature is generated according to sig=Ed25519.sign(k_priv, hash). Although these formulas are expressly disclosed embodiments, other deterministic or cryptographically secure digest and signing schemes may be used in other implementations.

The content-address generator 608 may generate a content-addressed identifier, locator, or publication reference associated with the bundle 500 or associated publication artifact. The primary publisher 610 may publish the bundle, identifier, signature, metadata, or related artifacts to a first storage or publication target. The backup publisher 612 may replicate the same or related artifacts to one or more additional targets to improve availability, resilience, or auditability. The archive or release publisher 614 may publish to a formal archive, repository, release-management system, enterprise store, citation archive, or other destination. In some embodiments, the publication manifest 616 records the publication targets used, the identifiers returned, one or more timestamps, one or more acknowledgment states, one or more replication states, one or more availability states, or one or more content-addressed references associated with the publication event. In this way, the sign-and-publish subsystem 600 may support publication to a single destination, multiple parallel destinations, hierarchical destinations, or staged publication workflows.

The transparency-log entry builder 618 may generate a log entry associated with a publication event. In preferred embodiments, the entry contains one or more of a bundle identifier, a content-addressed identifier, a digest, a signature reference, a timestamp, an epoch identifier, and an index within an epoch. The transparency ledger 620 receives such entries and stores them in an append-only, tamper-evident, or otherwise verifiable form. In one embodiment, an entry may be represented conceptually as Entry=(epoch_id, bundle_identifier, hash, signature, timestamp). In some embodiments, the transparency ledger 620 organizes entries into epochs as bounded collections or batches of entries. In some embodiments, entries are organized into leaves within a Merkle structure, and a Merkle root is generated for a completed or current epoch. One or more inclusion proofs may then be generated so that a verifier can confirm that a particular publication entry is part of a committed epoch represented by the Merkle root. In some embodiments, an external or semi-external anchoring artifact is stored, referenced, or generated, such as a blockchain anchoring event, a notarization event, a consortium-log commitment, an enterprise log commitment, or another anchoring mechanism. In some embodiments, the maximum leaves per epoch may be bounded according to max_leaves_per_epoch=2\hat{ }depth, and in one disclosed embodiment depth=12 such that max_leaves_per_epoch=4096. These specific values are disclosed as examples and may vary in other embodiments.

The sign-and-publish subsystem 600 is not limited to a particular storage environment, key-management environment, or transparency implementation. In some embodiments, the key store 604 may include or communicate with an HSM, a secure enclave, a threshold-signature environment, a multi-signature environment, a remote signing service, or a local software key store. In some embodiments, the primary publisher 610, backup publisher 612, and archive or release publisher 614 may publish to content-addressed networks, repository releases, permanent archives, enterprise stores, write-once environments, or regulated retention systems. In some embodiments, the transparency ledger 620 may be public, private, consortium-based, internal, or hybrid. In some embodiments, the external anchoring artifact may be omitted, deferred, periodically generated, or generated per epoch, per bundle, or per policy-defined publication set. The sign-and-publish subsystem 600 therefore supports a flexible but deterministic publication architecture that can be adapted to scientific, enterprise, academic, industrial, or regulatory requirements while preserving machine-verifiable attestation and historical traceability.

Turning to FIG. 7, an example verifier 700 is shown. The verifier 700 may include a retrieval module 702, a hash recomputation module 704, a signature verification module 706, a correction recomputation module 708, a value comparator 710, a proof verifier 712, an anchor verifier 714, and a result generator 716 configured to generate one or more output states including a valid state 718, an invalid state 720, a warning state 722, and an extracted-constants output 724. In preferred embodiments, the retrieval module 702 retrieves a bundle, a bundle representation, a content-addressed object, a signature artifact, a publication manifest, a proof artifact, or associated metadata from one or more publication targets. The hash recomputation module 704 recomputes the digest from the retrieved bundle or canonical representation. The signature verification module 706 verifies the signature or other attestation artifact using one or more public keys, fingerprints, certificates, trust anchors, or key-status services. The correction recomputation module 708 independently recomputes one or more correction parameters and one or more corrected values from disclosed baseline inputs and correction metadata. The value comparator 710 compares the independently recomputed values with the values stored in the retrieved bundle. The proof verifier 712 verifies one or more inclusion proofs or related transparency artifacts, and the anchor verifier 714 verifies one or more corresponding anchor records where present. The result generator 716 then outputs one or more status results.

A significant advantage of the verifier 700 is that it need not trust the stored corrected values as authoritative merely because they are present in the bundle. Instead, the correction recomputation module 708 may recompute corrected outputs from the baseline values and the disclosed correction metadata.

In certain embodiments, the combination of (i) canonicalization determinism that produces byte-identical canonical bundle bytes across independent implementations, (ii) cryptographic attestation of the canonical bundle bytes or a digest thereof, (iii) a tamper-evident publication record (including Merkle-root commitment and inclusion proofs in some embodiments), and (iv) recomputation-based verification of corrected values from disclosed baseline inputs and correction metadata provides a technical improvement to computing system security and scientific-computation integrity. This improvement prevents silent value drift, tampering, and non-reproducible constant selection across distributed software environments by enabling independent verification of both bundle integrity and transformation correctness prior to downstream computational use.

In a preferred RP embodiment, the correction recomputation module 708 may recompute X_opt, R_RP, and delta_loop and may then recompute one or more corrected values according to C_recomputed=C*(1−delta_loop) or, in higher-order embodiments, according to C_recomputed=C*sum_{n=0 to N}(a_n*delta_loop\hat{ }n). Because the recomputation is independent, a malicious or malfunctioning publisher cannot successfully alter a corrected value without risking a mismatch detected by the value comparator 710. In this manner, the verifier 700 provides recomputation-based assurance in addition to bundle-integrity assurance.

The verifier 700 may support multiple verification scopes. In a full-verification mode, the retrieval module 702 obtains the bundle and associated artifacts, the hash recomputation module 704 recomputes the digest, the signature verification module 706 validates the signature, the correction recomputation module 708 recomputes one or more transformed values, the value comparator 710 confirms correspondence between recomputed and published values, the proof verifier 712 validates one or more inclusion proofs, and the anchor verifier 714 validates one or more anchor records. In other embodiments, the verifier 700 may operate in a signature-only mode, a provenance-only mode, a recalculation-only mode, a proof-only mode, a selected-subset verification mode, or an offline mode in which one or more cached roots, cached trust anchors, cached bundle copies, or cached key-status records are used. Thus, “verification” in the present disclosure encompasses both full verification and partial verification according to a chosen verification policy.

The result generator 716 may generate the valid state 718 when all required checks pass under the selected verification policy. The invalid state 720 may be generated when one or more mandatory checks fail, including by way of example a retrieval failure, schema failure, canonicalization mismatch, digest mismatch, signature mismatch, correction mismatch, proof mismatch, anchor mismatch, or key-status failure. The warning state 722 may be generated where the bundle is valid under a selected policy but one or more non-fatal conditions exist, such as a superseded-bundle condition, a replacement notice, a withdrawn-but-historically-valid condition, partial verification only, a stale root, a stale key-status record, an unsupported optional profile, or other advisory states. The extracted-constants output 724 may include one or more selected constants, selected fields, selected corrected values, selected baseline values, or generated outputs for use by build systems, notebooks, reports, simulations, firmware, or other downstream systems. In this manner, the verifier 700 is both a security and provenance tool and a practical extraction and integration tool.

The verifier 700 may be embodied in many forms. In some embodiments, the verifier 700 is a command-line tool. In some embodiments, the verifier 700 is a browser-based verifier. In some embodiments, the verifier 700 is a Python package or notebook integration. In some embodiments, the verifier 700 is an embedded verifier for use in constrained environments. In some embodiments, the verifier 700 is part of an enterprise service, build pipeline, CI/CD gate, compliance-report engine, or regulator-facing verification portal. In some embodiments, the verifier 700 produces machine-readable outputs and human-readable reports. In some embodiments, the verifier 700 is integrated with the downstream injector environment 120 or downstream scientific application 122 shown in FIG. 1. Accordingly, the verifier 700 may be deployed wherever an independently verifiable constant bundle is needed.

In some embodiments, verification output is consumed by downstream machine logic rather than merely displayed to a user, such that a build system, runtime environment, simulator, firmware generator, compliance gate, or deployment controller proceeds only when the bundle satisfies one or more required verification conditions. In some embodiments, a failed signature check, correction mismatch, proof mismatch, lifecycle-status mismatch, or policy mismatch causes automatic blocking of downstream use, while a verified bundle is promoted for machine consumption without requiring manual reinterpretation.

FIG. 8 illustrates an example version manager 800 associated with an earlier bundle 802, a later bundle 804, a supersedes link 806, a replacement notice 808, a deprecation marker 810, a withdrawn marker 812, a preserved historical bundle 814, a history query interface 816, and a supersedence graph 818. The version manager 800 may maintain relationships among bundles published across different source releases, correction-profile versions, schema versions, signing-key epochs, or publication events. In some embodiments, when a new source release becomes available, the system 100 re-ingests the new baseline data, applies one or more correction policies, and publishes the later bundle 804. The later bundle 804 may identify the earlier bundle 802 by way of the supersedes link 806. In some embodiments, the replacement notice 808 indicates that the later bundle 804 replaces the earlier bundle 802 because of corrected content, improved metadata, a changed correction policy, a changed proof structure, a changed key state, or another reason. The deprecation marker 810 may indicate that a bundle remains historically valid but is no longer preferred for current use. The withdrawn marker 812 may indicate that a bundle should no longer be used for current operational purposes, even though the preserved historical bundle 814 may remain accessible and independently verifiable.

The history query interface 816 may allow a user, system, auditor, or verifier to discover earlier bundles, later bundles, supersedence chains, replacement chains, withdrawal states, or version-compatibility information. The supersedence graph 818 may represent one-to-one, one-to-many, many-to-one, staged, branched, or merged relationships among bundles. For example, one baseline source release may produce multiple later bundles 804 corresponding to different correction profiles, different theory tags, different deployment profiles, different signing environments, or different compliance regimes. Likewise, multiple earlier bundles 802 may be superseded by a single harmonized later bundle 804. The version manager 800 may therefore represent linear chains, branches, merges, or multi-profile release families. In some embodiments, the verifier 700 uses information from the version manager 800, including the supersedes link 806, replacement notice 808, deprecation marker 810, withdrawn marker 812, preserved historical bundle 814, history query interface 816, or supersedence graph 818, to generate warning or advisory outputs.

The version manager 800 provides an important advantage in that it supports authenticated change over time without erasing history. In many conventional systems, older releases are overwritten, silently replaced, or left ambiguously discoverable. By contrast, in preferred embodiments of the present invention, the earlier bundle 802 remains historically available, the later bundle 804 is explicitly related thereto, and the nature of the relationship is recorded through one or more of the supersedes link 806, replacement notice 808, deprecation marker 810, withdrawn marker 812, preserved historical bundle 814, history query interface 816, and supersedence graph 818. This approach supports auditability, reproducibility, later dispute resolution, scientific comparison, and regulator review, while still allowing users to identify the presently preferred bundle. Such explicit lifecycle management is especially useful in regulated, enterprise, scientific, and archival environments in which later correction, supersedence, or withdrawal of a release must not destroy the evidentiary value of the earlier publication.

The systems and methods described in connection with FIGS. 1-8 may be implemented in software, hardware, firmware, or any combination thereof. The various modules, engines, stores, interfaces, publishers, verifiers, and managers described herein may be combined or separated, centralized or distributed, synchronous or asynchronous, local or remote, and stateful or stateless, depending on implementation requirements. The order of operations described herein may be varied, repeated, parallelized, partially omitted, supplemented, or conditionally executed.

Likewise, the data structures described herein may be extended with additional metadata, proof material, compatibility fields, compliance fields, deployment fields, theory tags, security annotations, or lifecycle annotations. Although the present disclosure includes preferred embodiments directed to Recognition-Physics-derived correction policies, the broader authenticated constant-ledger architecture disclosed herein may be applied to any deterministic correction or transformation policy consistent with the claims.

As used herein, an “engine,” “module,” “generator,” “validator,” “maker,” “manager,” or similar functional block may comprise: (i) one or more processors and memory storing instructions that, when executed, perform the described functions; (ii) dedicated hardware logic (including secure elements or hardware security modules where applicable); or (iii) any combination of (i) and (ii). Such blocks may be implemented as software components, services, libraries, firmware, or hardware circuits, and may communicate through one or more buses, networks, inter-process channels, or application programming interfaces.

In certain embodiments, the invention may further support integration with scientific build systems, runtime injection environments, notebooks, audit systems, archive systems, enterprise mirrors, streaming transport systems, and multi-theory comparison infrastructures, even though such integration components are not each shown as separate figures in the reduced eight-figure set. The absence of a separate drawing for any such variation should not be construed as excluding such embodiments, because the present disclosure expressly contemplates that verified bundles, extracted constants, publication manifests, proofs, version relationships, and correction metadata may be consumed, displayed, transported, or further processed in a wide variety of downstream contexts. The present invention therefore encompasses both the core authenticated ledger pipeline and a broad range of deployment, verification, lifecycle, and interoperability embodiments built upon that core.

In additional embodiments the system 100 supports a broad range of implementation variations, deployment configurations, publication environments, verification modes, and integration pathways beyond those expressly shown in FIGS. 1-8. The invention is not limited to a single storage architecture, a single publication mechanism, a single verification environment, or a single scientific workflow. Rather, the authenticated constant-ledger architecture disclosed herein may be implemented in standalone, enterprise, cloud, hybrid, local, embedded, academic, regulatory, or consortium environments, while preserving the core functions of ingesting baseline constant data, deterministically generating corrected outputs, canonicalizing and attesting to a bundle, recording tamper-evident publication information, and enabling independent verification of authenticity, provenance, and transformation correctness.

In some embodiments, the baseline sources 102 may include one or more standards-body datasets, one or more institutional datasets, one or more enterprise-maintained reference datasets, one or more regulator-approved baseline datasets, one or more mirrored datasets, or one or more internally curated baseline sets. In some embodiments, different source releases may be ingested side by side and preserved as distinct source families, with the source release field 416 and source release field 506 preserving the distinctions between releases. In some embodiments, the ingestion engine 104 and the pipeline of FIG. 2 may further classify constants by category, application domain, uncertainty class, exactness status, or publication profile. In other embodiments, the ingestion engine 104 may enrich ingested data with source hashes, acquisition timestamps, source-locator metadata, mirror metadata, authentication metadata, or source-trust metadata stored in the metadata store 222. The invention therefore supports not only ingestion of a single table, but long-term management of a family of baseline datasets that may evolve over time and may originate from multiple technically relevant sources.

In additional embodiments, the correction engine 300 may apply different correction policies to different subsets of constants. For example, one category of constants may be processed by the first-order correction branch 310, a second category may be processed by the higher-order correction branch 312, and a third category may be preserved as baseline-only records with annotation metadata but no corrected value. In some embodiments, the correction-policy selector 302 selects a correction profile based on the intended downstream use, such as a scientific-computation profile, a regulator-facing profile, a conservative baseline-preservation profile, an enterprise validation profile, an experimental-theory comparison profile, or a profile tied to a specific software environment. In some embodiments, multiple corrected values may be derived for a single baseline value and stored in association with different policy identifiers, theory tags, or methodology tags, thereby enabling side-by-side comparison of different deterministic transformations while preserving a common provenance envelope. In still other embodiments, the coefficient store 314 may be implemented as a local table, a signed coefficient bundle, a remotely retrievable coefficient manifest, a hardware-backed store, or a policy-governed coefficient service.

In certain embodiments, the RP-specific correction path may be supplemented by broader Recognition-Science metadata while preserving a clean separation between internally derived values and externally reported values. In such embodiments, one or more RS-native values may be associated with the correction policy, with one or more corresponding SI display values generated only through an explicit reporting or calibration seam. This distinction is useful where an internal derivation framework produces quantities in an internal algebraic or dimensionless structure but the bundle must still report values in a conventional external unit system for scientific interoperability, standards comparison, or downstream software use. In preferred embodiments, the bundle preserves the fact that a baseline standards-body value remains the official reference value, while any corrected computational-use value is explicitly identified as such. This separation reduces ambiguity in prosecution and implementation by making clear that the ledger infrastructure distributes provenance-bound transformations without purporting to redefine the standards-body baseline itself.

In some embodiments, the canonical bundle 500 may be specialized for different publication purposes. A full-release bundle may contain an entire constant set for a source release. A subset bundle may contain only selected constant entries 518, such as constants needed for a specific simulation, instrument, or regulated workflow. A comparison bundle may contain multiple corrected outputs associated with a common baseline input so that different methodologies can be compared within a single canonical artifact. A delta bundle may contain only changes relative to an earlier bundle identified by the supersedes field 520. An audit bundle may be configured to include enhanced provenance information, publication manifest information, proof references, and lifecycle metadata for compliance-heavy environments. In some embodiments, bundle creation may be policy-driven such that the canonicalizer 526 generates different bundle variants from the same underlying corrected-record output 322 depending on the intended publication environment. In this manner, the invention supports not only a single canonical bundle form, but a family of deterministic bundle forms derived from common authenticated inputs.

In further embodiments, the sign-and-publish subsystem 600 supports alternative key-management and signature arrangements. In some implementations, the key store 604 holds a local signing key. In other implementations, the key store 604 interfaces with an HSM, a secure enclave, a remote signing appliance, a threshold-signature coordinator, or an enterprise key-management service. In some embodiments, the signature generator 606 produces a single signature. In other embodiments, the signature generator 606 produces multiple signatures corresponding to multiple institutions, multiple policy authorities, multiple environments, or multiple roles. In certain embodiments, a threshold-signature process is used so that publication requires authorization from a minimum number of designated signers. In still other embodiments, key rotation is explicitly supported such that a later bundle 804 may be generated under a new key while still preserving verifiability of earlier bundles 802 under a retired or historical key. In some embodiments, key-status metadata, successor-key metadata, revocation metadata, or trust-anchor metadata is made available to the verifier 700 so that the result generator 716 can distinguish between an otherwise valid signature under a retired historical key and an invalid signature under an unauthorized key.

In some embodiments, the transparency ledger 620 is implemented as a public ledger, while in other embodiments it is implemented as a private enterprise log, a consortium transparency service, a regulator-specific log, or a hybrid arrangement in which an internal transparency structure is periodically anchored externally through an external anchoring artifact. In some embodiments, epochs are closed based on entry count, time interval, policy triggers, release events, or regulator requirements. One or more inclusion proofs may be generated immediately on publication, generated on request, regenerated from retained ledger state, or distributed together with the publication manifest 616. In some embodiments, the external anchoring artifact comprises a blockchain transaction or commitment. In other embodiments, the external anchoring artifact comprises a notarized timestamp, trusted hardware attestation, enterprise notarization, archival certificate, or equivalent external commitment artifact. Thus, the transparency and anchoring layer is adaptable to different trust models while still preserving append-only or tamper-evident publication semantics.

In additional embodiments, the verifier 700 may be configured for specialized downstream uses. In a scientific-software integration embodiment, the extracted-constants output 724 may generate a header file, configuration file, serialized runtime object, memory image, or software-library input for use in a build or execution environment. In a notebook embodiment, the extracted-constants output 724 may present selected constants together with provenance annotations, verification status, and source-release metadata to a notebook runtime. In a browser embodiment, the verifier 700 may provide human-readable verification results for public or internal review. In an embedded embodiment, the verifier 700 may operate against cached roots and cached baseline data to support constrained devices. In a regulator-facing embodiment, the result generator 716 may output a report tailored to audit review, including the bundle identifier, proof status, anchor status, source release, correction profile, and lifecycle status. In a build-gate embodiment, the verifier 700 may cause a build or deployment to fail if the bundle is invalid, withdrawn, or otherwise non-compliant with a selected policy.

In some embodiments, the version manager 800 supports not only supersedence and replacement, but also branching release families and multi-profile coexistence. For example, an earlier bundle 802 may lead to multiple later bundles 804 corresponding to different correction frameworks, different publication jurisdictions, different signing authorities, different deployment environments, or different compliance modes. In some embodiments, the supersedence graph 818 preserves the entire family relationship rather than reducing version history to a single linear chain. In some embodiments, the history query interface 816 permits queries by source release, correction profile, publication date, lifecycle state, signing environment, theory tag, or downstream application family. In this manner, the invention supports historical preservation without sacrificing practical discoverability of the currently preferred bundle for a given use case.

The present invention is also well suited to integration with downstream systems that consume verified constant data. In certain embodiments, the downstream injector environment 120 may correspond to a runtime patching system, a binary instrumentation system, a compiled-binary modification system, or a software-injection environment that consumes verified constants from the system 100. In other embodiments, the downstream scientific application 122 may correspond to a simulation platform, a numerical solver, a calibration system, a digital twin, a firmware generator, a validation system, an academic workflow, or an enterprise analytics environment. The invention thereby provides an authenticated source of truth for transformed constant data, rather than merely a static publication repository. Because the verifier 700 can independently validate authenticity and transformation correctness before downstream use, the system reduces the risk that incorrect or tampered constants will be silently propagated into scientific or regulated workflows.

In further embodiments, the invention supports streaming and subscription-based delivery of authenticated constant updates. In such embodiments, publication of a new bundle by the sign-and-publish subsystem 600 may trigger a notification, stream update, message, or subscription event to downstream subscribers. A subscriber may then retrieve the new bundle, verify it using the verifier 700, and update a local store, cache, or configuration only if the new bundle satisfies policy-defined requirements. Such requirements may include valid signature, valid inclusion proof, acceptable source release, approved correction profile, non-withdrawn lifecycle state, or compatibility with a downstream application. In some embodiments, the version manager 800 assists in determining whether the new bundle should replace or coexist with an earlier local bundle. In this manner, the invention supports controlled propagation of corrected constant data across distributed software and institutional environments.

The invention additionally supports multi-theory embodiments in which the correction engine 300, canonical bundle 500, and version manager 800 handle multiple theory-tagged correction families. In such embodiments, a baseline constant may be associated with a Recognition-Physics-derived corrected value, one or more alternate deterministic corrected values, or both, with each value stored together with a corresponding theory tag, policy identifier, or methodology indicator. A verifier 700 operating under a selected verification policy may then validate only one theory profile or may validate a comparison bundle across multiple profiles. This allows the authenticated provenance infrastructure disclosed herein to remain useful even where different deterministic transformation frameworks coexist, while still preserving the important distinction between official baseline values and policy-specific computational-use values.

In some embodiments, one or more worked examples may be carried out using the system 100. By way of non-limiting example, a source dataset 200 corresponding to a released baseline constant table may be received through the acquisition interface 202, parsed by the parser 204, mapped by the schema mapper 206, normalized by the normalization module 216, and stored in the baseline record store 220. The correction engine 300 may then determine delta_loop through the correction-parameter generator 304 and X_opt calculator 306, apply a first-order correction through the first-order correction branch 310 and corrected-value calculator 316, and output corrected records through the corrected-record output 322. The canonical bundle maker 108 may assemble the canonical bundle 500, the canonicalizer 526 may generate canonical bytes, the hash generator 602 may compute a digest, the signature generator 606 may generate a signature, the primary publisher 610 and backup publisher 612 may publish the bundle, and the transparency-log entry builder 618 may add the corresponding entry to the transparency ledger 620. The verifier 700 may then retrieve the published artifact, recompute the digest and corrected values, validate one or more inclusion proofs and one or more external anchoring artifacts where present, and output the valid state 718. Although this description follows one preferred flow, other flows may omit steps, reorder steps, parallelize steps, or apply alternative policies.

From the foregoing, it will be appreciated that the invention provides a technical architecture for authenticated ingestion, deterministic transformation, canonical packaging, cryptographic attestation, tamper-evident publication, independent verification, and historical lifecycle management of physical-constant datasets. The invention is therefore useful not only as a publication mechanism, but as a provenance-preserving infrastructure for scientific reproducibility, regulatory traceability, enterprise data governance, and verified computational deployment. The disclosed embodiments provide strong written-description support for broad platform claims, narrower RP-specific correction claims, data-structure claims, verification claims, lifecycle claims, integration claims, and deployment claims, while preserving flexibility for alternate correction policies, alternate publication environments, alternate signature schemes, alternate transparency models, and alternate downstream uses.

In addition, the method embodiments, system embodiments, and computer-readable-medium embodiments disclosed herein share a single common inventive concept and a unified technical pipeline: (i) ingesting baseline physical-constant data; (ii) deterministically generating corrected values under a disclosed correction policy; (iii) assembling baseline and corrected values into a canonical machine-readable bundle; (iv) generating cryptographic attestation for the canonical bundle; (v) recording a tamper-evident publication record; and (vi) enabling verification that includes recomputation-based validation of corrected values from disclosed baseline inputs and correction metadata. Accordingly, the statutory classes (method, system, and computer-readable medium) are disclosed as different claim formats directed to the same core technical architecture and are intended to be commensurate in scope across implementations.

1. A computer-implemented method for generating and distributing a provenance-preserving corrected physical-constant bundle, the method comprising: receiving baseline physical-constant data from one or more designated baseline sources; validating and normalizing the baseline physical-constant data; determining, with a correction engine, one or more corrected values for one or more baseline physical constants according to a deterministic correction policy; generating a plurality of constant records that include baseline values and corrected values associated with the one or more baseline physical constants; assembling the plurality of constant records into a canonical machine-readable bundle; generating at least one cryptographic attestation artifact for the canonical machine-readable bundle; publishing the canonical machine-readable bundle or an identifier associated with the canonical machine-readable bundle to one or more storage or distribution targets; recording a tamper-evident publication record associated with the canonical machine-readable bundle; and enabling verification of authenticity, provenance, and transformation integrity of the canonical machine-readable bundle.

2. The method of claim 1, wherein validating and normalizing the baseline physical-constant data comprises at least one of checking a numeric value for finiteness, checking a value for positivity where physically required, validating or normalizing a unit representation, validating uncertainty data, mapping source fields into a common schema, tagging a source release, handling a duplicate entry, or handling a missing or malformed field.

3. The method of claim 2, wherein the baseline physical-constant data is received in at least one of a CSV format, a JSON format, an XML format, an application-programming-interface response format, an archive format, a mirrored-repository format, or a local file format.

4. The method of claim 3, wherein the canonical machine-readable bundle stores, for at least one constant, both an official baseline value and a corrected computational-use value corresponding to the official baseline value.

5. The method of claim 4, wherein the canonical machine-readable bundle further stores an exactness indicator associated with a constant that is exact by definition.

6. The method of claim 5, wherein the deterministic correction policy comprises a global policy applied across a plurality of constants, a per-category policy, a per-constant policy, a profile-based policy, a theory-tagged policy, an annotation-only policy, or a comparison policy.

7. The method of claim 6, wherein the deterministic correction policy comprises a Recognition-Physics correction policy.

8. The method of claim 7, wherein determining the one or more corrected values comprises determining X_opt according to X_opt=phi/pi, wherein phi is the golden ratio and pi is the circle constant, using R_RP= 7/12, determining delta_loop according to delta_loop=X_opt\hat{ }(1+R_RP), and determining a corrected value according to C_star=C*(1−delta_loop).

9. The method of claim 8, wherein determining the one or more corrected values comprises determining a higher-order corrected value according to C_star=C*S, where S=(a_0*delta_loop\hat{ }0)+(a_1* delta_loop\hat{ }1)+ . . . +(a_N*delta_loop\hat{ }N) for an integer N>=1.

10. The method of claim 9, wherein the plurality of constant records includes, for at least one constant record, a name field, a symbol field, a baseline value field, a baseline uncertainty field, a corrected value field, a corrected uncertainty field, a unit field, a source release field, a correction-order field, a correction-parameter field, a provenance reference field, an engine-version field, an exactness flag, or a record hash.

11. The method of claim 10, wherein assembling the canonical machine-readable bundle comprises generating a deterministic canonical representation using deterministic key ordering, deterministic array ordering, deterministic numeric formatting, and a defined encoding format, such that two independent implementations that receive identical bundle content produce byte-identical canonical bundle bytes prior to hashing and signing.

12. The method of claim 11, wherein generating the at least one cryptographic attestation artifact comprises generating a digest of the canonical bundle bytes using a cryptographic hash function, and generating a digital signature over at least the digest using a digital signature algorithm, wherein the cryptographic hash function comprises SHA-256 and wherein the digital signature algorithm comprises Ed25519, and wherein recording the tamper-evident publication record comprises recording an entry in an append-only transparency ledger.

13. The method of claim 12, wherein recording the entry in the append-only transparency ledger comprises organizing a plurality of entries into a Merkle structure, generating a Merkle root associated with a set of entries, and generating an inclusion proof for at least one entry.

14. The method of claim 13, wherein enabling verification comprises retrieving the canonical machine-readable bundle, recomputing a digest for the canonical machine-readable bundle, verifying the digital signature, recomputing at least one corrected value from at least one baseline value and correction metadata, comparing the recomputed corrected value with a published corrected value, and verifying the inclusion proof.

15. The method of claim 14, wherein enabling verification comprises supporting a verification mode selected from full verification, signature-only verification, provenance-only verification, recalculation-only verification, proof-only verification, selected-subset verification, or offline verification using cached verification data.

16. The method of claim 15, further comprising publishing a later canonical machine-readable bundle that supersedes an earlier canonical machine-readable bundle while preserving the earlier canonical machine-readable bundle as a historically verifiable bundle.

17. A system for generating and distributing a provenance-preserving corrected physical-constant bundle, the system comprising: an ingestion engine configured to receive baseline physical-constant data from one or more designated baseline sources and to validate and normalize the baseline physical-constant data; a correction engine configured to determine one or more corrected values for one or more baseline physical constants according to a deterministic correction policy; a canonical bundle maker configured to assemble baseline values, corrected values, and associated metadata into a canonical machine-readable bundle; a sign-and-publish module configured to generate at least one cryptographic attestation artifact for the canonical machine-readable bundle, to publish the canonical machine-readable bundle or an identifier associated therewith to one or more storage or distribution targets, and to record a tamper-evident publication record associated with the canonical machine-readable bundle; and a verifier configured to verify authenticity, provenance, and transformation integrity of the canonical machine-readable bundle.

18. The system of claim 17, wherein the verifier is configured to retrieve the canonical machine-readable bundle, recompute a digest for the canonical machine-readable bundle, verify a digital signature, recompute at least one corrected value from at least one baseline value and correction metadata, compare the recomputed corrected value with a published corrected value, verify a transparency proof, verify an anchor record where present, and output a verification state comprising at least one of a valid state, an invalid state, or a warning state.

19. The system of claim 18, wherein the sign-and-publish module is configured to publish the canonical machine-readable bundle to one or more content-addressed storage targets, permanent archives, release repositories, enterprise stores, or write-once storage targets, and wherein the sign-and-publish module is further configured to use a key store comprising a local key store, a hardware security module, a secure enclave, a threshold-signature environment, a multi-signature environment, or a remote key-management service.

20. A non-transitory computer-readable medium storing instructions that, when executed by one or more processors, cause the one or more processors to: receive baseline physical-constant data from one or more designated baseline sources; validate and normalize the baseline physical-constant data; determine one or more corrected values for one or more baseline physical constants according to a deterministic correction policy; generate a plurality of constant records that include baseline values and corrected values associated with the one or more baseline physical constants; assemble the plurality of constant records into a canonical machine-readable bundle; generate at least one cryptographic attestation artifact for the canonical machine-readable bundle; publish the canonical machine-readable bundle or an identifier associated with the canonical machine-readable bundle to one or more storage or distribution targets; record a tamper-evident publication record associated with the canonical machine-readable bundle; and enable verification of authenticity, provenance, and transformation integrity of the canonical machine-readable bundle.
